(19) United States
(12) Patent Application Publication
(10) Pub. No.: US 2026/0070196 A1
(43) Pub. Date: Mar. 12, 2026

(54) COMPENSATING FOR CHANGES IN STRAIN AS SUBSEQUENT CONNECTORS ARE TIGHTENED

(71) Applicant: MILWAUKEE ELECTRIC TOOL CORPORATION, Brookfield, WI (US)

(72) Inventors: Dhananjai Bajpai, Evanston, IL (US); Geoffrey G. Norman, Hartford, WI (US)

(21) Appl. No.: 19/263,191

(22) Filed: Jul. 8, 2025

Related U.S. Application Data
(60) Provisional application No. 63/668,969, filed on Jul. 9, 2024.

(51) Int. Cl. B25B 23/14; B25B 21/02

(52) U.S. Cl. CPC B25B 23/1405; B25B 21/02

(57) ABSTRACT

An impact driver comprising a controller. The controller is configured to receive a number of connectors and, for each connector of a plurality of connectors equal to the number of connectors, determine, based on the number of connectors, a torque for the connector, wherein, when the connector is a connector other than a final connector tightened, the determined torque is associated with a level of strain greater than a desired level of strain, and tighten the connector using the torque determined for the connector.

### CROSS-REFERENCE TO RELATED APPLICATIONS

This application claims the benefit of, and priority to, U.S. Provisional Patent Application Ser. No. 63/668,969, filed Jul. 9, 2024, the entire contents of which are hereby incorporated by reference.

### FIELD

Embodiments described herein relate to power tools, and more specifically to power tools with impact mechanisms.

### SUMMARY

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

It should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible. The terms “processor” “central processing unit” and “CPU” are interchangeable unless otherwise stated. Where the terms “processor” or “central processing unit” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations.

In some aspects, the techniques described herein relate to an impact driver including: a controller, the controller configured to: receive a number of connectors associated with a fastening operation; for each connector of a number of connectors equal to the number of connectors, determine, based on the number of connectors and an overall desired torque value for the fastening operation, an individual desired torque value for each connector of the number of connectors. A first individual desired torque value for a first connector to be tightened is greater than an individual desired torque value for each of one or more subsequent connectors of the plurality of connectors to be tightened, and the individual desired torque values for each subsequent connector to be tightened is less than the individual desired torque value of a previous connector to be tightened. The controller is further configured to control an output of the impact driver to tighten each connector using the individual desired torque value determined for each connector to achieve the overall desired torque value for the fastening operation.

In some aspects, the techniques described herein relate to a process for controlling a power tool to compensate for changes in strain in a multiple connector fastening operation. The process includes receiving a number of connectors associated with the multiple connector fastening operation; determining, for each connector of a plurality of connectors equal to the number of connectors, an individual desired torque value for each connector of the plurality of connectors, based on the received number of connectors and an overall desired torque value for the fastening operation. A first individual desired torque value for a first connector to be tightened is greater than the individual desired torque value for each of one or more subsequent connectors of the plurality of connectors to be tightened. The individual desired torque values for cach subsequent connector to be tightened is less than the individual desired torque value of a previous connector to be tightened. The process further includes controlling an output of the power tool to tighten each connector of the plurality of connectors to be tightened to achieve the overall desired torque value for the multiple connector fastening operation.

In some aspects, the techniques described herein relate to an impact driver, including: a controller configured to receive a number of connectors associated with a fastening operation, receive a type of connector associated with the number of connectors. For each connector of a plurality of connectors equal to the number of connectors, determine a desired torque value for each connector based on the received type of connector. The controller is further configured to determine, based on the number of connectors, the type of connectors, and an overall desired torque value for the fastening operation, an individual desired torque value for each connector of the plurality of connectors. A first individual desired torque value for a first connector to be tightened is greater than an individual desired torque value for each of one or more subsequent connectors of the plurality of connectors to be tightened, and the individual desired torque values for each subsequent connector to be tightened is less than the individual desired torque value of a previous connector to be tightened. The controller is further configured to control an output of the impact driver to tighten each connector using the individual desired torque value determined for each connector to achieve the overall desired torque value for the fastening operation.

Other aspects of various embodiments will become apparent by consideration of the detailed description and accompanying drawings.

### BRIEF DESCRIPTION OF THE DRAWINGS

FIG. 1 illustrates a communication system according to an embodiment of the disclosure.

FIG. 2 illustrates a power tool of a communication system.

FIGS. 3A and 3B illustrate a schematic diagram of the power tool.

FIGS. 4A and 4B illustrate an impact mechanism of an impact driver according to one embodiment.

FIGS. 5A, 5B, 6A, 6B, 7A, 7B, 8A, and 8B illustrate an exemplary operation of a hammer and an anvil of the impact driver according to one embodiment.

FIG. 9A illustrates an anvil position sensor of the power tool.

FIG. 9B illustrates an anvil position sensor of the power tool.

FIG. 10 illustrates the output of the anvil position sensor of FIG. 9A as a function of the anvil position.

FIGS. 11A, 11B, and 11C illustrate a body portion of a power tool for supporting the anvil position sensor of FIGS. 9A or 9B.

FIGS. 12A and 12B illustrate an embodiment of an anvil assembly including a target positioned on the anvil shaft and a magnetic shield positioned between the target and the anvil lugs.

FIG. 13 illustrates a perspective view of an upper housing portion of the power tool of FIG. 2.

FIG. 14 illustrates a graph providing an example of an effect that flanging behavior of a component has on a strain placed on a connector as subsequent connectors are tightened, according to some embodiments.

FIG. 15 illustrates a graph providing an example of how a connector is overtightened to achieve a desired level of strain on the connector, according to some embodiments.

FIG. 16 illustrates a flowchart of an example method for compensating for changes in strain as subsequent connectors are tightened, according to some embodiments.

### DETAILED DESCRIPTION

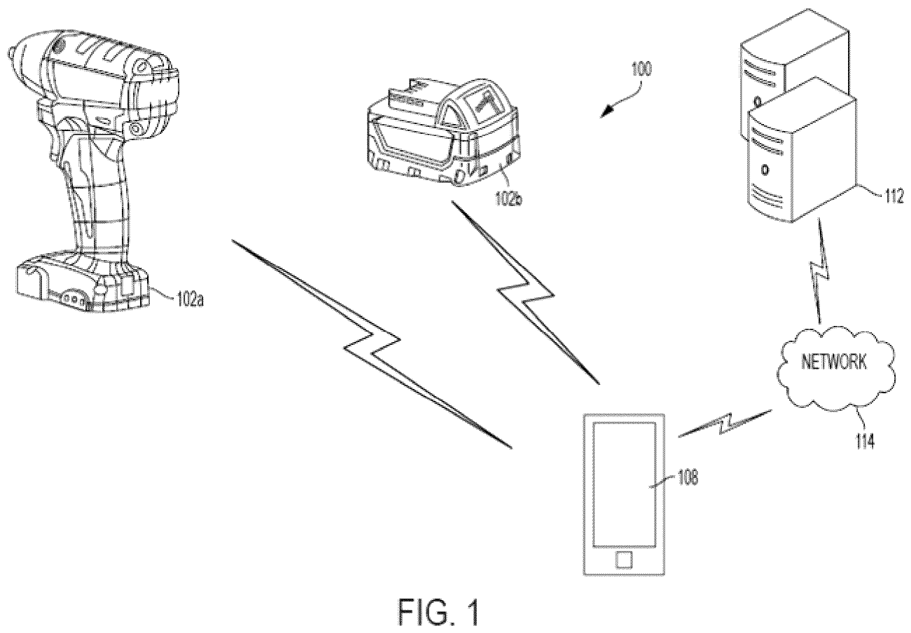

FIG. 1 illustrates a communication system 100. The communication system 100 includes power tool devices 102 and an external device 108. Each power tool device 102 (e.g., battery powered impact driver 102a and power tool battery pack 102b) and the external device 108 can communicate wirelessly while they are within a communication range of each other. Each power tool device 102 may communicate power tool status, power tool operation statistics, power tool identification, stored power tool usage information, power tool maintenance data, and the like. Therefore, using the external device 108, a user can access stored power tool usage or power tool maintenance data. With this tool data, a user can determine how the power tool device 102 has been used, whether maintenance is recommended or has been performed in the past, and identify malfunctioning components or other reasons for certain performance issues. The external device 108 can also transmit data to the power tool device 102 for power tool configuration, firmware updates, or to send commands (e.g., turn on a work light). The external device 108 also allows a user to set operational parameters, safety parameters, select tool modes, and the like for the power tool device 102.

The external device 108 may be, for example, a smart phone (as illustrated), a laptop computer, a tablet computer, a personal digital assistant (PDA), or another electronic device capable of communicating wirelessly with the power tool device 102 and providing a user interface. The external device 108 provides the user interface and allows a user to access and interact with tool information. The external device 108 can receive user inputs to determine operational parameters, enable or disable features, and the like. The user interface of the external device 108 provides an easy-to-use interface for the user to control and customize operation of the power tool.

The external device 108 includes a communication interface that is compatible with a wireless communication interface or module of the power tool device 102. The communication interface of the external device 108 may include a wireless communication controller (e.g., a Bluetooth® module), or a similar component. The external device 108, therefore, grants the user access to data related to the power tool device 102, and provides a user interface such that the user can interact with the controller of the power tool device 102.

In addition, as shown in FIG. 1, the external device 108 can also share the information obtained from the power tool device 102 with a remote server 112 connected by a network 114. The remote server 112 may be used to store the data obtained from the external device 108, provide additional functionality and services to the user, or a combination thereof. In one embodiment, storing the information on the remote server 112 allows a user to access the information from a plurality of different locations. In another embodiment, the remote server 112 may collect information from various users regarding their power tool devices and provide statistics or statistical measures to the user based on information obtained from the different power tools. For example, the remote server 112 may provide statistics regarding the experienced efficiency of the power tool device 102, typical usage of the power tool device 102, and other relevant characteristics and/or measures of the power tool device 102. The network 114 may include various networking elements (routers, hubs, switches, cellular towers, wired connections, wireless connections, etc.) for connecting to, for example, the Internet, a cellular data network, a local area network (LAN), a wide area network (WAN) or a combination thereof.

In some embodiments, the power tool device 102 may be configured to communicate directly with the server 112 through an additional wireless communication interface or with the same wireless communication interface that the power tool device 102 uses to communicate with the external device 108.

The power tool device 102 is configured to perform one or more specific tasks (e.g., drilling, cutting, fastening, pressing, lubricant application, sanding, heating, grinding, bending, forming, impacting, polishing, lighting, etc.). For example, an impact wrench is associated with the task of generating a rotational output (e.g., to drive a bit).

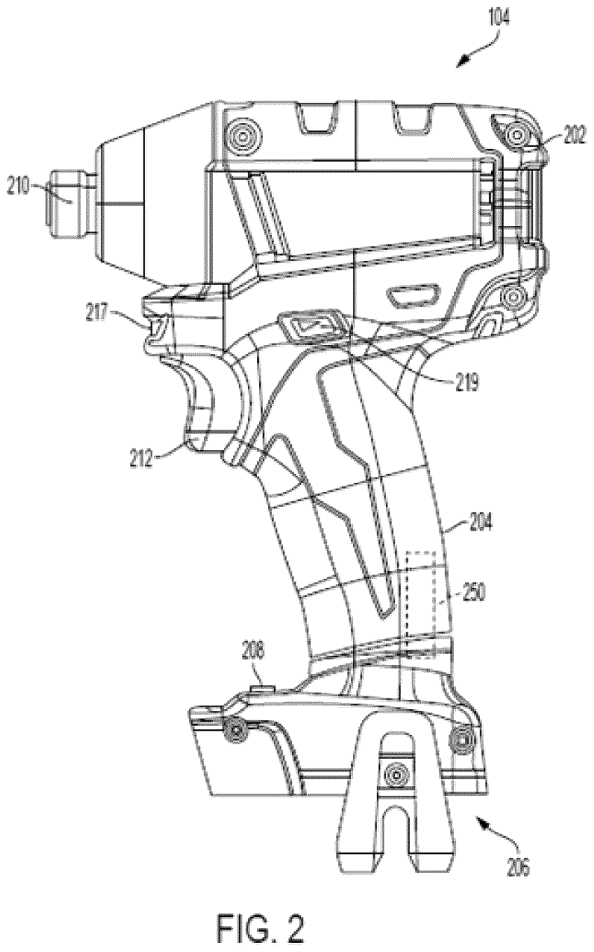

FIG. 2 illustrates an example of the power tool device 102, an impact driver 104. The impact driver 104 is representative of various types of power tools that operate within the system 100. Accordingly, the description with respect to the impact driver 104 in the system 100 is similarly applicable to other types of power tools, such as other power tools with impact mechanisms (e.g., impact wrenches and impacting angle drivers) and other suitable power tools. As shown in FIG. 2, the impact driver 104 includes an upper main body 202, a handle 204, a battery pack receiving portion 206, an output drive device 210, a trigger 212, a work light 217, and forward/reverse selector 219. The housing of the impact driver 104 (e.g., the main body 202 and the handle 204) are composed of a durable and light-weight plastic material. The drive device 210 is composed of a metal (e.g., steel). The drive device 210 on the impact driver 104 is a socket. However, other power tools may have a different drive device 210 specifically designed for the task associated with the other power tool. The battery pack receiving portion 206 is configured to receive and couple to the battery pack (e.g., 102b of FIG. 1) that provides power to the impact driver 104. The battery pack receiving portion 206 includes a connecting structure to engage a mechanism that secures the battery pack and a terminal block to electrically connect the battery pack to the impact driver 104. The mode pad 208 allows a user to select a mode of the impact driver 104 and indicates to the user the currently selected mode of the impact driver 104.

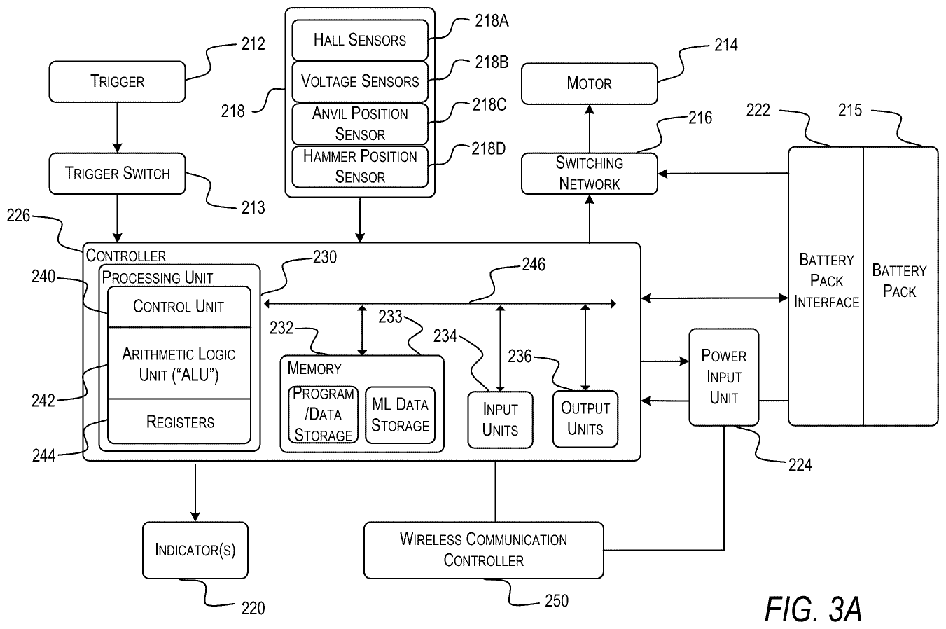

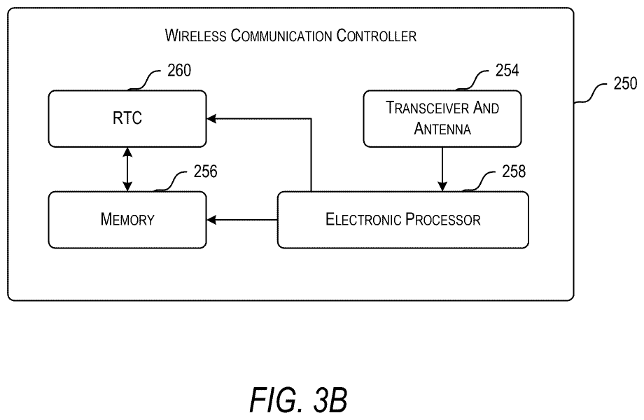

As shown in FIG. 3A, the impact driver 104 also includes a motor 214. The motor 214 actuates the drive device 210 and allows the drive device 210 to perform the particular task. A primary power source (e.g., a battery pack) 215 couples to the impact driver 104 and provides electrical power to energize the motor 214. The motor 214 is energized based on the position of the trigger 212. When the trigger 212 is depressed, the motor 214 is energized, and when the trigger 212 is released, the motor 214 is de-energized. In the illustrated embodiment, the trigger 212 extends partially down a length of the handle 204; however, in other embodiments the trigger 212 extends down the entire length of the handle 204 or may be positioned elsewhere on the impact driver 104. The trigger 212 is moveably coupled to the handle 204 such that the trigger 212 moves with respect to the tool housing. The trigger 212 is coupled to a push rod, which is engageable with a trigger switch 213 (see FIG. 3A). The trigger 212 moves in a first direction towards the handle 204, when the trigger 212 is depressed by the user. The trigger 212 is biased (e.g., with a spring) such that it moves in a second direction away from the handle 204, when the trigger 212 is released by the user. When the trigger 212 is depressed by the user, the push rod activates the trigger switch 213, and when the trigger 212 is released by the user, the trigger switch 213 is deactivated. In other embodiments, the trigger 212 is coupled to an electrical trigger switch 213. In such embodiments, the trigger switch 213 may include, for example, a transistor. Additionally, for such electrical trigger switch embodiments, the trigger 212 may not include a push rod to activate a mechanical switch. Rather, the electrical trigger switch 213 may be activated by, for example, a position sensor (e.g., a Hall-Effect sensor) that relays information about the relative position of the trigger 212 to the tool housing or electrical trigger switch 213. The trigger switch 213 outputs a signal indicative of the position of the trigger 212. In some instances, the signal is binary and indicates either that the trigger 212 is depressed or released. In other instances, the signal indicates the position of the trigger 212 with more precision. For example, the trigger switch 213 may output an analog signal that various from 0 to 5 volts depending on the extent that the trigger 212 is depressed. For example, 0 V output indicates that the trigger 212 is released, 1 V output indicates that the trigger 212 is 20% depressed, 2 V output indicates that the trigger 212 is 40% depressed, 3 V output indicates that the trigger 212 is 60% depressed, 4 V output indicates that the trigger 212 is 80% depressed, and 5 V indicates that the trigger 212 is 100% depressed. However, these are merely examples and alternative thresholds (and an alternative number of thresholds) may be used to provide different gradients of depression precision. The signal output by the trigger switch 213 may be analog or digital.

As also shown in FIG. 3A, the impact driver 104 also includes a switching network 216, sensors 218, indicators 220, the battery pack interface 222, a power input unit 224, a controller 226, and a wireless communication controller 250. The battery pack interface 222 is coupled to the controller 226 and couples to the battery pack 215. The battery pack interface 222 includes a combination of mechanical (e.g., the battery pack receiving portion 206) and electrical components configured to and operable for interfacing (e.g., mechanically, electrically, and communicatively connecting) the impact driver 104 with the battery pack 215. The battery pack interface 222 is coupled to the power input unit 224. The battery pack interface 222 transmits the power received from the battery pack 215 to the power input unit 224. The power input unit 224 includes active and/or passive components (e.g., voltage step-down controllers, voltage converters, rectifiers, filters, etc.) to regulate or control the power received through the battery pack interface 222 and to the wireless communication controller 250 and controller 226.

The switching network 216 enables the controller 226 to control the operation of the motor 214. Generally, when the trigger 212 is depressed as indicated by an output of the trigger switch 213, electrical current is supplied from the battery pack interface 222 to the motor 214, via the switching network 216. When the trigger 212 is not depressed, electrical current is not supplied from the battery pack interface 222 to the motor 214.

In response to the controller 226 receiving the activation signal from the trigger switch 213, the controller 226 activates the switching network 216 to provide power to the motor 214. The switching network 216 controls the amount of current available to the motor 214 and thereby controls the speed and torque output of the motor 214. The switching network 216 may include numerous field-effect transistors (“FETs”), bipolar transistors, or other types of electrical switches. For instance, the switching network 216 may include a six-FET bridge that receives pulse-width modulated (“PWM”) signals from the controller 226 to drive the motor 214.

The sensors 218 are coupled to the controller 226 and communicate to the controller 226 various signals indicative of different parameters of the impact driver 104 or the motor 214. The sensors 218 include one or more Hall sensors 218a, one or more voltage sensors 218b, one or more anvil position sensors 218c (for example, anvil rotation sensors), one or more hammer position sensors 218d (for example, hammer translation sensors), among other sensors, such as, for example, one or more current sensors, one or more temperature sensors, and one or more torque sensors. Each Hall sensor 218a outputs motor feedback information to the controller 226, such as an indication (e.g., a pulse) when a magnet of the motor's rotor rotates across the face of that Hall sensor. Based on the motor feedback information from the Hall sensors 218a, the controller 226 can determine the position, velocity, and acceleration of the rotor. In response to the motor feedback information and the signals from the trigger switch 213, the controller 226 transmits control signals to control the switching network 216 to drive the motor 214. For instance, by selectively enabling and disabling the FETs of the switching network 216, power received via the battery pack interface 222 is selectively applied to stator coils of the motor 214 to cause rotation of its rotor. The motor feedback information is used by the controller 226 to ensure proper timing of control signals to the switching network 216 and, in some instances, to provide closed-loop feedback to control the speed of the motor 214 to be at a desired level. The one or more voltage sensors 218b may provide voltage signals to the controller 226 indicative of a voltage of the battery pack 215.

The indicators 220 are also coupled to the controller 226 and receive control signals from the controller 226 to turn on and off or otherwise convey information based on different states of the impact driver 104. The indicators 220 include, for example, one or more light-emitting diodes (“LEDs”), or a display screen. The indicators 220 can be configured to display conditions of, or information associated with, the impact driver 104. For example, the indicators 220 may be configured to indicate measured electrical characteristics of the impact driver 104, the status of the impact driver 104, the mode of the power tool, etc. The indicators 220 may also include elements to convey information to a user through audible or tactile outputs.

As described above, the controller 226 is electrically and/or communicatively connected to a variety of modules or components of the impact driver 104. In some embodiments, the controller 226 includes a plurality of electrical and electronic components that provide power, operational control, and protection to the components and modules within the controller 226 and/or impact driver 104. For example, the controller 226 includes, among other things, a processing unit 230 (e.g., a microprocessor, a microcontroller, electronic processor, electronic controller, or another suitable programmable device), a memory 232, input units 234, and output units 236. The processing unit 230 (herein, electronic processor 230) includes, among other things, a control unit 240, an arithmetic logic unit (“ALU”) 242, and a plurality of registers 244 (shown as a group of registers in FIG. 3A). In some embodiments, the controller 226 is implemented partially or entirely on a semiconductor (e.g., a field-programmable gate array [“FPGA”] semiconductor) chip, such as a chip developed through a register transfer level (“RTL”) design process.

The memory 232 includes, for example, a program/data storage area and a machine learning data storage area 233. The program storage area and the data storage area can include combinations of different types of memory, such as a read-only memory (“ROM”), a random access memory (“RAM”) (e.g., dynamic RAM [“DRAM”], a synchronous DRAM [“SDRAM”], etc.), an electrically erasable programmable read-only memory (“EEPROM”), a flash memory, a hard disk, a secure digital (“SD”) card, or other suitable magnetic, optical, physical, or electronic memory device(s). The electronic processor 230 is connected to the memory 232 and executes software instructions that are stored in a memory 232 (e.g., RAM 232 during execution), a ROM 232 (e.g., on a generally permanent basis), or another non-transitory computer readable medium such as another memory or a disc). Software included in the implementation of the impact driver 104 can be stored in the memory 232 of the controller 226 (e.g., in the program storage area). The software includes, for example, firmware, one or more applications, program data, filters, rules, one or more program modules, and other executable instructions. The controller 226 is configured to retrieve from memory and execute, among other things, instructions related to the control processes and methods described herein. The controller 226 is also configured to store power tool information on the memory 232 including operational data, information identifying the type of tool, a unique identifier for the particular tool, and other information relevant to operating or maintaining the impact driver 104. The tool usage information, such as current levels, motor speed, motor acceleration, motor direction, number of impacts, may be captured or inferred from data output by the sensor(s) 218. Such power tool information may then be accessed by a user with the external device 108. In other constructions, the controller 226 includes additional, fewer, or different components.

The wireless communication controller 250 is coupled to the controller 226. In the illustrated embodiment, the wireless communication controller 250 is located near the foot of the impact driver 104 (see FIG. 2) to save space and ensure that the magnetic activity of the motor 214 does not affect the wireless communication between the impact driver 104 and the external device 108.

As shown in FIG. 3B, the wireless communication controller 250 includes a radio transceiver and an antenna 254, a memory 256, an electronic processor 258, and a real-time clock (“RTC”) 260. The radio transceiver and antenna 254 operate together to send and receive wireless messages to and from the external device 108 and the electronic processor 258. The memory 256 can store instructions to be implemented by the electronic processor 258 and/or may store data related to communications between the impact driver 104 and the external device 108 or the like. The electronic processor 258 for the wireless communication controller 250 controls wireless communications between the impact driver 104 and the external device 108. For example, the electronic processor 258 associated with the wireless communication controller 250 buffers incoming and/or outgoing data, communicates with the controller 226, and determines the communication protocol and/or settings to use in wireless communications.

In the illustrated embodiment, the wireless communication controller 250 is a Bluetooth® controller. The Bluetooth® controller communicates with the external device 108 employing the Bluetooth® protocol. Therefore, in the illustrated embodiment, the external device 108 and the impact driver 104 are within a communication range (i.e., in proximity) of each other while they exchange data. In other embodiments, the wireless communication controller 250 communicates using other protocols (e.g., Wi-Fi®, cellular protocols, a proprietary protocol, etc.) over a different type of wireless network. For example, the wireless communication controller 250 may be configured to communicate via Wi-Fi® through a WAN, such as the Internet or a LAN, or to communicate through a piconet (e.g., using infrared or near-field communications (“NFC”). The communication via the wireless communication controller 250 may be encrypted to protect the data exchanged between the impact driver 104 and the external device 108/network 114 from third parties.

The wireless communication controller 250 is configured to receive data from the power tool controller 226 and relay the information to the external device 108 via the transceiver and antenna 254. In a similar manner, the wireless communication controller 250 is configured to receive information (e.g., configuration and programming information) from the external device 108 via the transceiver and antenna 254 and relay the information to the power tool controller 226.

The RTC 260 increments and keeps time independently of the other power tool components. The RTC 260 receives power from the battery pack 215 when the battery pack 215 is connected to the impact driver 104 and receives power from the back-up power source 252 when the battery pack 215 is not connected to the impact driver 104. Having the RTC 260 as an independently powered clock enables time stamping of operational data (stored in memory 232 for later export) and a security feature whereby a lockout time is set by a user and the tool is locked-out when the time of the RTC 260 exceeds the set lockout time.

The memory 232 stores various identifying information of the impact driver 104 including a unique binary identifier (UBID), an American Standard Code for Information Interchange [“ASCII”] serial number, an ASCII nickname, and a decimal catalog number. The UBID both uniquely identifies the type of tool and provides a unique serial number for each impact driver 104. Additional or alternative techniques for uniquely identifying the impact driver 104 are used in some embodiments.

FIGS. 4A and 4B show an impact mechanism 400, which is an example of an impact mechanism of the impact driver 104. Based on the design of the impact mechanism 400 of the impact driver 104, the motor 214 rotates at least a predetermined number of degrees between impacts (i.e., 180 degrees for the impact mechanism 400). The impact mechanism 400 includes a hammer 405 with outwardly extending lugs 407 and an anvil 410 with outwardly extending lugs 415. The anvil 410 is coupled to the output drive device 210. In some embodiments, the output drive device 210 includes a gearbox output for interfacing with a gearbox to drive another output shaft. FIGS. 4A and 4B illustrate a helical bevel gearbox output, however, other type of gearbox outputs may be used, such as a straight bevel, a spiral bevel, or the like. In some embodiments, the gearbox output is omitted and the output drive device 210 directly interfaces with a workpiece. For example, the output drive device 210 may be a socket as shown in FIG. 2, a chuck, or some other suitable type of workpiece interface. During operation, impacting occurs when the anvil 410 encounters a certain amount of resistance, e.g., when driving a fastener into a workpiece. When this resistance is met, the hammer 405 continues to rotate. A spring coupled to the back-side of the hammer 405 causes the hammer 405 to disengage the anvil 410 by axially retreating. Once disengaged, the hammer 405 will advance both axially and rotationally to again engage (i.e., impact) the anvil 410. When the impact mechanism 400 is operated, the hammer lugs 407 impact the anvil lugs 415 every 180 degrees. Accordingly, when the impact driver 104 is impacting, the hammer 405 rotates 180 degrees without the anvil 410, impacts the anvil 410, and then rotates with the anvil 410 a certain amount before repeating this process. For further reference on the functionality of the impact mechanism 400, see, for instance, the impact mechanism discussed in U.S. application Ser. No. 14/210,812, filed Mar. 14, 2014, which is herein incorporated by reference in its entirety. Although two hammer lugs 407 that impact the anvil lugs 415 every 180 degrees are shown, more than two hammer lugs 407 could be used, which would change the degrees of separation (e.g., three hammer lugs that impact the anvil lugs 415 every 120 degrees), according to various embodiments. Additionally, in some embodiments, the hammer lugs may impact the anvil lugs less frequently or more frequently than every 180 degrees (for example, by skipping hammer lugs).

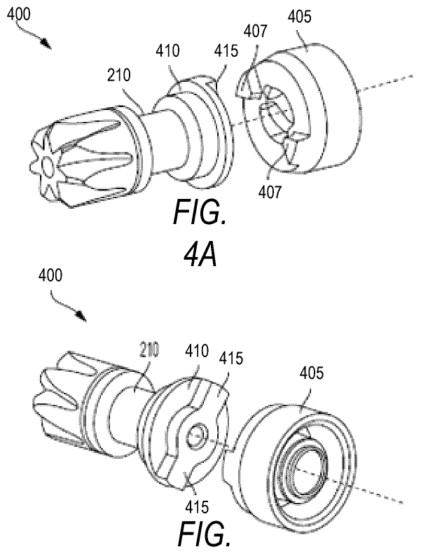

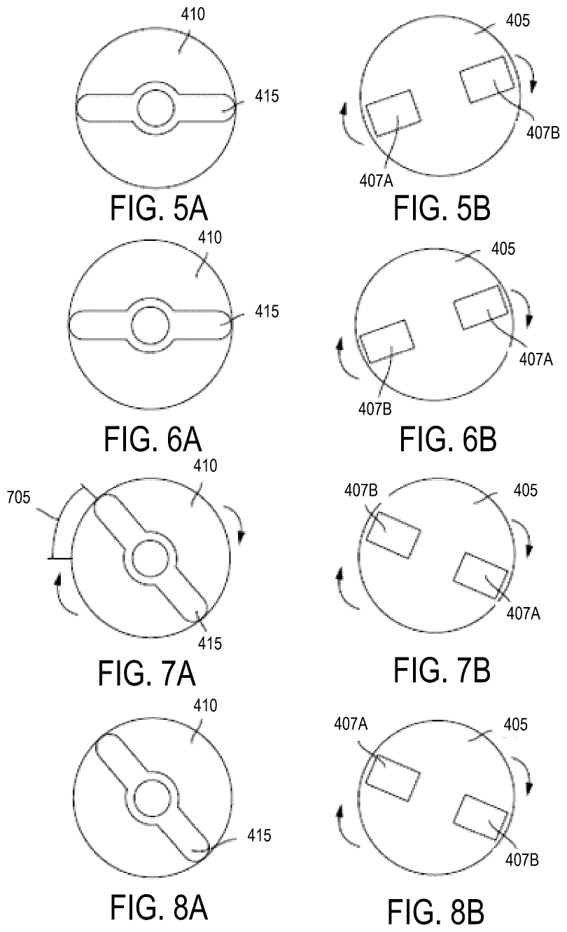

The controller 226 can determine how far the hammer 405 and the anvil 410 rotated together by monitoring the angle of rotation of the shaft of the motor 214 between impacts using one or more of the Hall sensors 218a, by monitoring the anvil position using the anvil position sensor 218c, by monitoring the hammer position using the hammer position sensor 218d, or a combination thereof. For example, when the impact driver 104 is driving an anchor into a softer joint, the hammer 405 may rotate 225 degrees between impacts. In this example of 225 degrees, 45 degrees of the rotation includes hammer 405 and anvil 410 engaged with each other and 180 degrees includes just the hammer 405 rotating before the hammer lugs 407 impact the anvil 410 again. FIGS. 5-8 illustrate this exemplary rotation of the hammer 405 and the anvil 410 at different stages of operation.

FIGS. 5A and 5B show the rotational positions of the anvil 410 and the hammer 405, respectively, at a first timing (e.g., just after the hammer lugs 407A, 407B disengage the lugs 415 of the anvil 410 (i.e., after an impact and engaged rotation by both the hammer 405 and the anvil 410 has occurred)). FIGS. 5A show a first rotational anvil position of the anvil 410 at the first timing. FIG. 5B shows a first rotational hammer position of the hammer 405 at the first timing (e.g., just as the hammer lugs 407A and 407B begin to axially retreat from the anvil 410). After the hammer 405 disengages the anvil 410 by axially retreating, the hammer 405 continues to rotate (as indicated by the arrows in FIG. 5B) while the anvil 410 remains in the first rotational anvil position. FIGS. 6A and 6B show the rotational positions of the anvil 410 and the hammer 405, respectively, at a second timing (e.g., at a first moment of impact). As shown in FIG. 6A, the anvil 410 remains in the first rotational anvil position at the second timing. As shown in FIG. 6B, the hammer 405 has rotated 180 degrees to a second rotational hammer position (as indicated by the arrows in FIG. 6B, and the change of positions of hammer lugs 407A and 407B from FIG. 5B to FIG. 5B).

Upon impact between the hammer lugs 407A and 407B and the anvil lugs 415, the hammer 405 and the anvil 410 rotate together in the same rotational direction (as indicated by the arrows in FIGS. 7A and 7B) which generates torque that is provided to the output drive device 210 to drive an anchor into concrete, for example. FIGS. 7A and 7B show the rotational positions of the anvil 410 and the hammer 405, respectively, at a third timing (e.g., after the hammer 405 again disengages the anvil 410 by axially retreating). As an example, in FIGS. 7A and 7B, at a third timing, the hammer 405 is in a third rotational hammer position and the anvil 410 is in a second rotational anvil position that is approximately 45 degrees from the first rotational anvil position as indicated by drive angle 705. The drive angle 705 indicates the number of degrees that the anvil 410 rotated between events (e.g., between non-movement periods or between impacts) which corresponds to the number of degrees that the output drive device 210 rotated between events.

As stated above, after the hammer 405 disengages the anvil 410, the hammer 405 continues to rotate (as indicated by the arrows in FIG. 8B) while the anvil 410 remains in the same rotational position. FIGS. 8A and 8B show the rotational positions of the anvil 410 and the hammer 405, respectively, at a fourth timing (e.g., a second moment of impact is occurring). As shown in FIG. 8A, the anvil 410 remains in the second rotational anvil position at the fourth timing. As shown in FIG. 8B, the hammer 405 has rotated 180 degrees from the third rotational hammer position to a fourth rotational hammer position. Relative to FIG. 6B (i.e., the first timing (e.g., when the first moment of impact occurred)), the hammer 405 has rotated 225 degrees (i.e., 45 degrees while engaged with the anvil 410 after the previous impact and 180 degrees after disengaging from the anvil 410). Although specific degrees of rotation are used for exemplary purposes above, it can be appreciated that the specific degrees of rotation may vary.

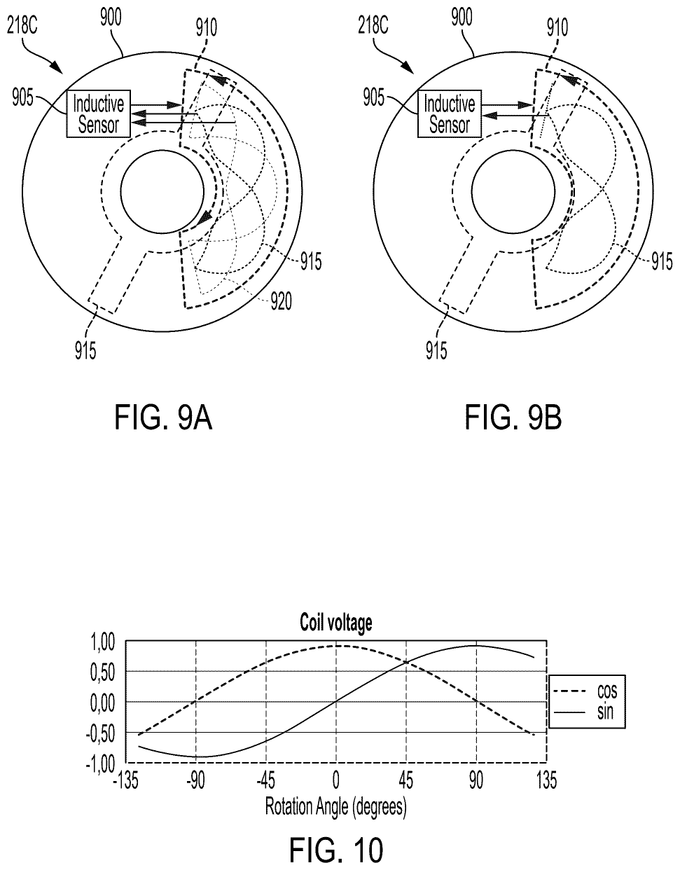

FIG. 9A illustrates the anvil position sensor 218c of the power tool 102. The anvil position sensor 218c includes a printed circuit board 900 supporting or associated with an inductive sensor 905, a transmitting circuit trace 910, a first receiving circuit trace 915, and a second receiving circuit trace 920. The inductive sensor 905 injects a current into the transmitting circuit trace 110 to generate a magnetic field. As seen in FIG. 4, the anvil 410 includes lugs 415 that are engaged by the lugs 407 on the hammer 405 to rotate the anvil 410. As the anvil 410 rotates, the lugs 415 pass through the magnetic field generated by the injection of the signal into the transmitting circuit trace 910. Eddy currents are generated in the lugs 415 of the anvil 410. The eddy currents generate a magnetic field that passes across the receiving circuit traces 915, 920. Current induced in the receiving circuit traces 915, 920 is used by the inductive sensor 905 to determine the position of the anvil lug 415 with respect to the receiving circuit traces 915, 920.

In some embodiments, the receiving circuit traces 915, 920 are sinusoidal in shape but offset by 90°, so that when the anvil 410 rotates, the voltage in one of the receiving circuit traces 915, 920 is a sine wave and the voltage in the other receiving circuit trace 915, 920 is a cosine wave. The voltage output of the two receiving traces 915, 920 can then be used by the controller 226 to determine the location (e.g., rotational angle) of the anvil 410 with respect to the receiving circuit traces. In some embodiments, the angle is generated by the controller 226 using an arctangent function,

$$a = arc tan \frac{{V}_{sin}}{{V}_{cos}} .$$

In some embodiments, the anvil position sensor 218c achieves a resolution of approximately 0.15° for detection of the position of the anvil lug 415 and has a detection accuracy of greater than 98%.

In some instances, the hammer position sensor 218d has a similar or the same design as the anvil position sensor 218c. For example, the hammer position sensor 218d includes the printed circuit board 900 supporting or associated with the inductive sensor 905, the transmitting circuit trace 910, the first receiving circuit trace 915, and the second receiving circuit trace 920. As the hammer 405 advances axially and rotationally to engage the anvil 410, the hammer lugs 407 pass through the magnetic field generated by the injection of the signal into the transmitting circuit trace 910. Eddy currents are generated in the hammer lugs 407 and generate a magnetic field that passes across the receiving circuit traces 915, 920. Current induced in the receiving circuit traces 915, 920 is used by the inductive sensor 905 to determine the position of the hammer lug 407 with respect to the receiving circuit traces 915, 920. In some embodiments, a portion of the hammer 405 other than the hammer lugs 407 is/are used to determine the movement of the hammer 405. In some embodiments, the hammer position sensor 218d is configured in a straight line for detecting the translational movement of the hammer 405 (e.g., as opposed to being curved like the anvil position sensor 218c).

FIG. 10 illustrates the output of the anvil sensor of FIG. 9A as a function of an anvil rotation angle. In the embodiment illustrated in FIG. 9A, the printed circuit board 900 includes approximately 180° of traces (e.g., across approximately half of the circumference of the printed circuit board 900). In other embodiments, the traces for transmitting and receiving extend across approximately the entire surface of the printed circuit board 900 (e.g., approximately 360° around the circumference of the printed circuit board 900). In some embodiments, a target length (e.g., anvil lug 415) is approximately 20-50% of the receiving circuit trace 915, 920's period length.

In some embodiments, the anvil position sensor 218c includes a single receiving circuit trace 915, as shown in FIG. 9B. The use of a single receiving circuit trace 915 reduces the footprint of the Printed Circuit Board Assembly (PCBA). In some embodiments, the controller 226 uses an arc-trigonometric function to resolve angle, but the output of the anvil position sensor 218c is non-linear. The use of two receiving circuit traces 915 and 920 increases robustness to air-gap and interference of neighboring components.

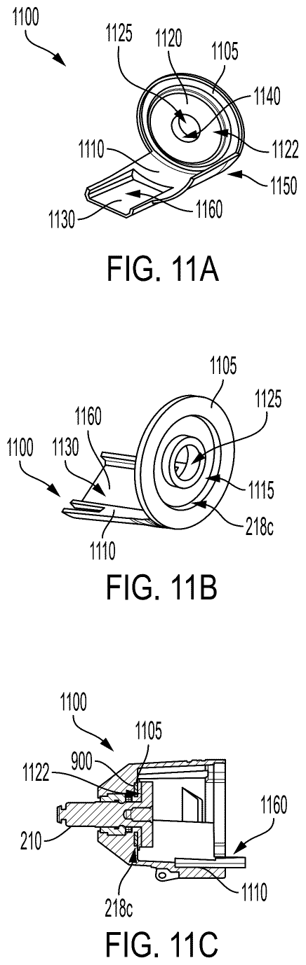

FIGS. 11A-11C illustrate a body portion 1100 of the power tool 102 positioned near the anvil 410 for supporting the anvil position sensor 218c. The body portion 1100 includes a ring portion 1105 and a tray portion 1110 extending from the ring portion 1105. The ring portion 1105 defines a first recess 1115 for receiving the printed circuit board 900 shown in FIGS. 9A and 9B, a thrust support surface 1120 of an anvil thrust support 1122, and an opening 1125. The drive device 210 extends through the opening 1125, and the thrust support surface engages the anvil 410 during operation. The opening 1125 may provide a clearance 1140. A wire routing 1150 may be provided on an outer diameter of a boat between the boat and the gear case inner diameter. The tray portion 1110 defines a second recess 1130 in which a hammer impact sensor 1160 may be mounted. As described above, the hammer impact sensor 1160 detects an impact between the hammer 405 and the anvil 410. For example, a hammer impact sensor 1160 may measure axial position, acceleration, sound, or vibration to detect an impact.

The radial span of the circuit traces 910, 915, 920 on the printed circuit board 900 may vary depending on the configuration of the anvil 410. For an anvil 410 with two lugs 415, the span may be about 180 degrees, since the second lug 415 enters the span covered by the circuit traces 910, 915, 920 as the first lug 415 leaves. Thus, the first lug 415 interfaces with the anvil position sensor 218c during a first portion of the rotation path of the anvil 410, and the second lug 415 interfaces with the anvil position sensor 218c during a second portion of the rotation path of the anvil 410. If more lugs 415 are present, a smaller span for the anvil position sensor 218c may be used.

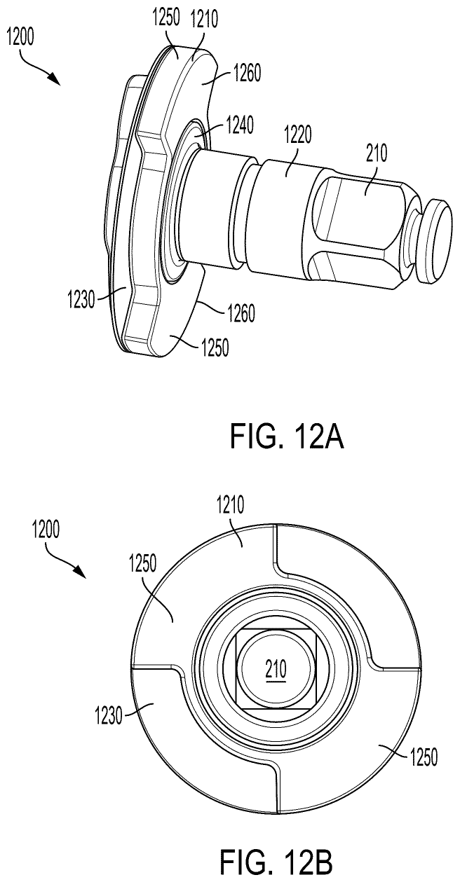

FIGS. 12A and 12B illustrate an embodiment of an anvil assembly 1200 including a target 1210 positioned on a shaft 1220 of the output drive device 210 and a magnetic shield 1230 positioned between the target 1210 and the anvil lugs 415. The magnetic shield 1230 is, for example, made of a material having a magnetic permeability that is greater than air (e.g., greater than 1.26×10⁻⁶ Henries/meter [“H/m”]). In some embodiments, the magnetic shield 1230 is made of a material having a magnetic permeability that is greater than 1×10⁻⁴ H/m. In some embodiments, the magnetic shield 1230 is made of carbon steel. In other embodiments, the magnetic shield 1230 is made of ferrite or another suitable magnetic material. In some embodiments, the target 1210 is a ring member that is mounted on the shaft 1220, such as on an outward projection 1240 of the shaft 1220. In some embodiments, the target 1210 is secured via interference fit or via adhesive. The target 1210 includes target lugs 1250 with radial surfaces 1260 for interfacing with the anvil position sensor 218C.

Referring to FIG. 12A, the radial surfaces 1260 of the target lugs 1250 are positioned adjacent the anvil position sensor 218C. The magnetic shield 1230 magnetically isolates the target lugs 1250 from the anvil lugs 415 and the hammer lugs 407A, 407B to mitigate magnetic interference caused by the positioning of the hammer lugs 407A, 407B proximate the anvil lugs 415 during impact and rotation. The radial span of the circuit traces 910, 915, 920 on the printed circuit board 900 may vary depending on the configuration of the target 1210 and the target lugs 1250. For a target 1210 with two target lugs 1250, the span can be about 180 degrees, since the second target lug 1250 enters the span covered by the circuit traces 910, 915, 920 as the first target lug 1250 leaves. Thus, the first target lug 1250 interfaces with the anvil position sensor 218c during a first portion of the rotation path of the anvil 410, and the second target lug 1250 interfaces with the anvil position sensor 218c during a second portion of the rotation path of the anvil 410. If more target lugs 1250 are present, a smaller span for the anvil position sensor 218c may be used. In other embodiments, a sensor span of between 180 degrees and 360 degrees is used.

The anvil may be unshielded (without a shield) or shielded (e.g., with the 1230 of FIGS. 12A and 12B). The sensor output of the unshielded anvil may provide a less robust signal for determining position compared to the shielded anvil. For example, when the hammer is at a rest position against the anvil, the shielded design provides a more robust signal (e.g., greater signal strength, greater signal to noise ratio, etc.) than the unshielded design. The output of the sensor has a relationship to the anvil position (degrees). The shielded sensor output may be, for example, 99% accurate to ideal performance.

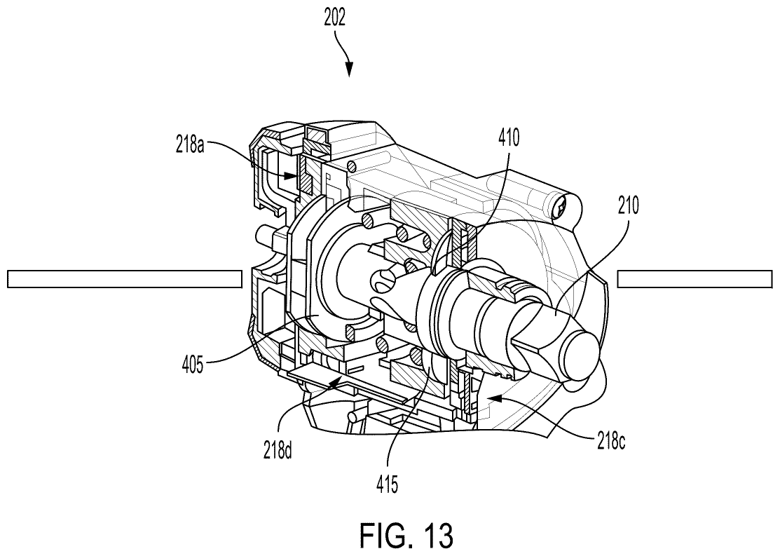

FIG. 13 illustrates a perspective view of the upper housing portion 202 with a portion of the housing removed. The anvil position sensor 218c is positioned adjacent to the anvil 410 and, particularly, the anvil lugs 415. In some instances, the anvil position sensor 218c is positioned below the anvil 410. Similarly, the hammer position sensor 218d is positioned adjacent to the hammer 405 and, particularly, the hammer lugs 407 (not shown). In some instances, the hammer position sensor 218d is positioned below the hammer 405. In some embodiments, the anvil position sensor 218c and the hammer position sensor 218d share wiring such that signals from the anvil position sensor 218c travel through a circuit board associated with the hammer position sensor 218d.

The controller 226 may refer to anvil position signals from the anvil position sensor 218c, hammer position signals from the hammer position sensor 218d, and signals from the Hall sensors 218a indicative of rotor speed to determine an estimated torque output of the impact driver 104.

When some components (for example, tires (such as automobile tires), Victaulic couplings, pipe flanges, and the like) are installed using a plurality of connectors (for example, bolts, lug nuts, screws, and the like), the components exhibit a flanging behavior. In other words, the strain placed on a tightened connector may decrease as subsequent connectors are tightened.

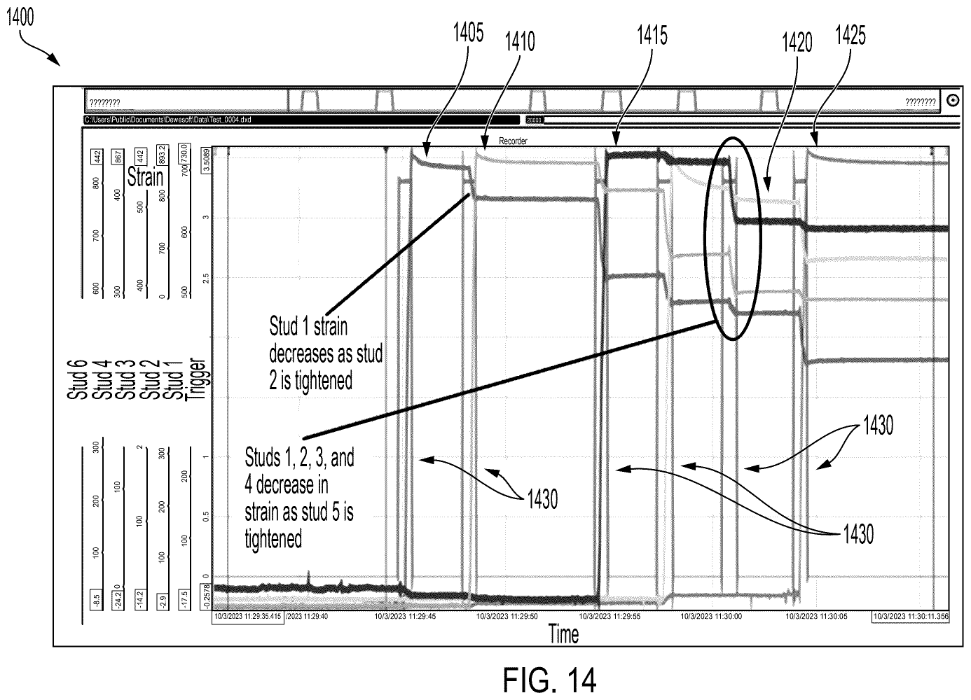

FIG. 14 provides a graph 1400 that illustrates an example of the effect that flanging behavior of a component has on a strain placed on a connector as subsequent connectors are tightened. In the graph 1400 illustrated in FIG. 14, a component (such as a wheel) is installed using six connectors (for example, six bolts or lug nuts). In the graph 1400, the y-axis represents strain and the x-axis represents time. In some embodiments, strain is measured in micrometers of stretch per meter (μm/m). Line 1405 represents the strain placed on the first connector as it is tightened when the component is installed, line 1410 represents the strain on the second connector that is tightened, line 1415 represents the strain placed on the third connector that is tightened, the line 1420 represents the strain placed on the fourth connector that is tightened, and line 1425 represents the strain placed on the sixth connector that is tightened. The pulsations 1430 each represent a depression of the trigger 212. Each depression of the trigger 212 corresponds to a tightening of one of the six connectors required to install the component. It should be noted that while the graph 1400 does not include a line representing the strain placed on the fifth connector, the graph 1400 does include a pulsation 1430 corresponding to the depression of the trigger 212 to tighten the fifth connector.

As can be seen in the graph 1400, the strain on the first connector decreases significantly from the time that the first connector is fastened to the time that the sixth connector is fastened. As illustrated in by the line 1405, the strain on the first connector decreases each time the trigger 212 is depressed and a subsequent connector (for example, the second connector, the third connector, the fourth connector, the fifth connector, or the sixth connector) is tightened. The strain on the second connector also decreases from the time that the second connector is fastened to the time that the sixth connector is fastened, but strain on the second connector does not decrease as significantly as the strain on the first connector. The strains on the third connector and the fourth connector also decrease as subsequent connectors (for example, the fifth connector and the sixth connector) are tightened. The strain on the sixth and final connector to be tightened does not decrease in a meaningful way because it is the last connector to be tightened.

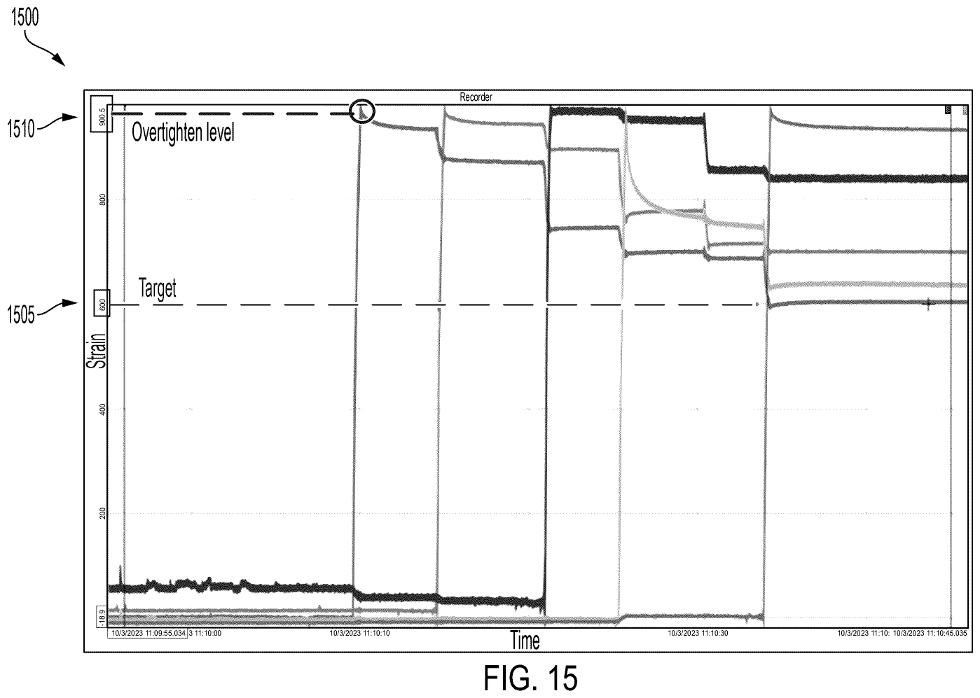

Therefore, in order to achieve a desired strain on each connector after the tightening of all connectors required to install a component is complete, each connector tightened prior to the final connector being tightened may be overtightened to compensate for decreasing strain as subsequent connectors are tightened. For example, FIG. 15 includes a graph 1500 illustrating that, in order for a first connector to have a desired or target level of strain 1505 placed on it once cach subsequent connector is tightened, the first connector must initially be overtightened such that a level of strain 1510 greater than the desired level of strain 1505 is placed on the first connector.

The embodiments described herein are directed to compensating for changes in strain as subsequent connectors are tightened.

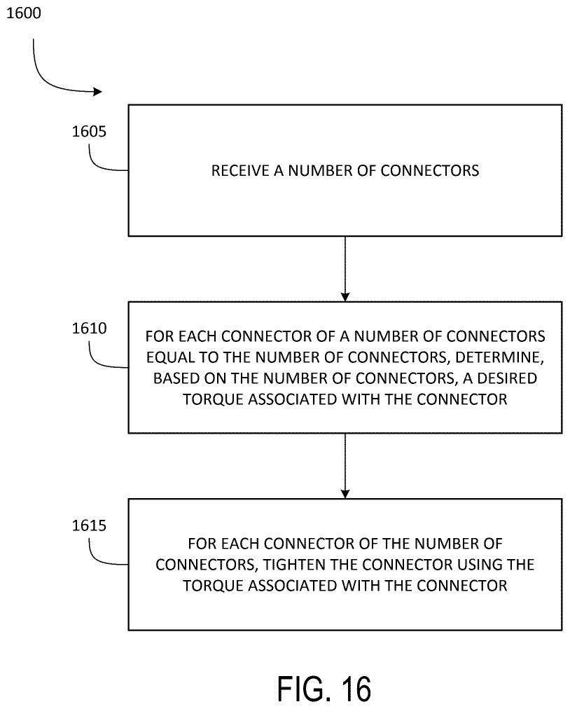

FIG. 16 provides a flowchart of an example process 1600 for compensating for changes in strain as subsequent connectors are tightened. In some embodiments, the process 1600 begins in response to the controller 226 receiving, via, for example, the mode pad 208, a selection of a mode associated with performing the process 1600. Example modes may include lug nut mode, screw mode, etc. In some embodiments, the process 1600 begins at process block 1605 in response to the controller 226 receiving an indication of a number of connectors required to install a component (for example a number of lug nuts required to be tightened to attach a car wheel). For example, a user may enter a number of connectors via a user interface of the external device 108 and the controller 226 may receive a number of connectors required to install a component from the external device 108 via the wireless communication controller 250. In other examples, the controller 226 may receive the number of connectors via the user interface XXX of the power tool YYY.

At process block 1610, for each connector of a number of connectors equal to the number of indicated connectors, the controller 226 determines, based on the number of connectors, a required torque associated with each connector. In some embodiments, for each connector other than the final connector tightened, the controller 226 determines a required torque associated with the connector to be greater than a torque required to achieve a desired level of strain on the connector. In some embodiments, the greatest required torque is associated with (or determined for) the first connector tightened and the required torque determined for each subsequent connector decreases until the final connector is tightened. In some embodiments, the final connector tightened is associated with a torque required to achieve a desired level of strain for a given application. For example, where the desired level of strain on each connector is 120 ft-lbs, the required torque for the final connector tightened may be 120 ft-lbs, while each previously tightened connector may have a required torque greater than 120 ft-lbs in order to overcome the flanging effect. In some embodiments, the desired level of strain placed on a connector is the same for each connector of the plurality of connectors. In some embodiments, the desired level of strain is the desired level of strain placed on a connector once each connector of the plurality of connectors is tightened.

For example, where a number of connectors required to install a component is three, the first connector that is tightened may be associated with a first torque value, the second connector that is tightened may be associated with a second torque value that is less than the first torque value, and the third and final connector tightened may be associated with a third torque value that is equal to a torque value required to achieve a desired level of strain on the third connector. The third torque value is also less than both the first torque value and the second torque value.

In some embodiments, the controller 226 may determine a torque value associated with cach connector associated with a component, using a mathematical equation retrieved from memory 232. The mathematical equation that is retrieved from memory 232 may depend on the number of connectors received at block 1605. Other factors that the mathematical equation may take into account may include type of component, connector type, and/or other factors as required for a given application. Example connector types may include bolts, nuts, lug nuts, screws, and/or other connector types as required for a given application.

In other embodiments, the controller 226 may determine a torque value associated with cach connector using a machine learning model retrieved from memory 232, such as from the machine learning data storage area.

To implement the machine learning model, the controller 226 is configured to learn a general rule or model that maps the inputs to the outputs based on the provided example input-output pairs. The machine learning algorithm may be configured to perform machine learning using various types of methods. For example, the controller 226 may implement the machine learning program using decision tree learning (such as random decision forests), associates rule learning, artificial neural networks, recurrent artificial neural networks, long short term memory neural networks, inductive logic programming, support vector machines, clustering, Bayesian networks, reinforcement learning, representation learning, similarity and metric learning, sparse dictionary learning, genetic algorithms, k-nearest neighbor (KNN), among others, such as those listed in Table 1 below. In some instances, the machine learning model is implemented by the server 112 or a combination of the server 112 and the controller 226.

TABLE 1

| | |
|---|---|
| Recurrent | Recurrent Neural Networks [“RNNs”], Long Short-Term Memory |
| Models | [“LSTM”] models, Gated Recurrent Unit [“GRU”] models, Markov |
| | Processes, Reinforcement learning |
| Non-Recurrent | Deep Neural Network [“DNN”], Convolutional Neural Network [“CNN”], |
| Models | Support Vector Machines [“SVM”], Anomaly detection (ex: Principle |
| | Component Analysis [“PCA”]), logistic regression, decision trees/forests, |
| | ensemble methods (combining models), polynomial/Bayesian/other |
| | regressions, Stochastic Gradient Descent [“SGD”], Linear Discriminant |
| | Analysis [“LDA”], Quadratic Discriminant Analysis [“QDA”], Nearest |
| | neighbors classifications/regression, naïve Bayes, attention networks, |
| | transformer networks, etc. |

The controller 226 is programmed and trained to perform a particular task using the machine learning model. For example, in some embodiments, the controller 226 is trained to determine a torque value associated with a connector (for example, a torque value to use to tighten a connector to ensure a desired strain on the connector is achieved after each connector required to install a component is tightened), or the like. The training examples used to train the machine learning model may be graphs or tables of torque value used to tighten connectors and strains placed on connectors once each connector required to install a component is tightened. Training data examples may also include a number of connectors required to install a component, a type of connector being tightened, a type of component being installed, a combination of the foregoing, or the like. The training examples may be previously collected training examples, from, for example, a plurality of the same type of power tools. For example, the training examples may have been previously collected from a plurality of power tools of the same type (e.g., impact drivers) over a span of, for example, one year.

A number of different training examples is provided to the controller 226. The controller 226 may use these training examples to generate a machine learning model (e.g., a rule, a set of equations, and the like) that helps categorize or estimate the required output (e.g., torque value) based on new input data. The controller 226 may weight different training examples differently to, for example, prioritize different conditions or inputs and outputs to and from the controller 226. For example, certain observed operating characteristics may be weighed more heavily than others.

In one example, the controller 226 may implement an artificial neural network. The artificial neural network includes an input layer, a plurality of hidden layers or nodes, and an output layer. Typically, the input layer includes as many nodes as inputs provided to the controller 226. The number (and the type) of inputs provided to the machine controller 226 may vary based on the particular task for the controller 226. Accordingly, the input layer of the artificial neural network of the controller 226 may have a different number of nodes based on the particular task for the controller 226. The input layer connects to the hidden layers. The number of hidden layers varies and may depend on the particular task for the controller 226.

Additionally, each hidden layer may have a different number of nodes and may be connected to the next layer differently. For example, each node of the input layer may be connected to cach node of the first hidden layer. The connection between each node of the input layer and each node of the first hidden layer may be assigned a weight parameter. Additionally, each node of the neural network may also be assigned a bias value. However, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is associated with an activation function. The activation function defines how the hidden layer is to process the input received from the input layer or from a previous input layer. These activation functions may vary and be based on not only the type of task associated with the controller 226, but may also vary based on the specific type of hidden layer implemented.

Each hidden layer may perform a different function. For example, some hidden layers can be convolutional hidden layers which can, in some instances, reduce the dimensionality of the inputs, while other hidden layers can perform statistical functions such as max pooling, which may reduce a group of inputs to the maximum value, an averaging layer, among others. In some of the hidden layers (also referred to as “dense layers”), each node is connected to each node of the next hidden layer. Some neural networks including more than, for example, three hidden layers may be considered deep neural networks. The last hidden layer is connected to the output layer. Similar to the input layer, the output layer typically has the same number of nodes as the possible outputs.

During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until a training condition is met. The training condition may correspond to, for example, a predetermined number of training examples being used, a minimum accuracy threshold being reached during training and validation, a predetermined number of validation iterations being completed, and the like. Different types of training algorithms can be used to adjust the bias values and the weights of the node connection based on the training examples. The training algorithms may include, for example, gradient descent, newton's method, conjugate gradient, quasi newton, and levenberg marquardt, among others.

In some embodiments, the machine learning model receives, as an input, the number of connectors received at block 1605. In some embodiments, the machine learning model may receive inputs in addition to the number of connectors received at block 1605. For example, the machine learning model may receive an indication of a type of connector being tightened, a type of component being installed, a combination of the foregoing, or the like. In some embodiments, the controller 226 may be configured to periodically retrain the machine learning model using, for example, data received from the server 112 regarding a plurality of power tools similar to the impact driver 104. In other embodiments, the controller 226 receives an updated machine learning model from, for example, the server 112. The updated machine learning model may be the result of the server 112 re-training the machine learning model using data collected from a plurality of power tools similar to the impact driver 104. In some embodiments, the machine learning model may determine a torque that accounts for the likelihood of bad impacts delivered by the impact driver 104 and energy lost when converting potential energy to kinetic energy.

At block 1615, the controller 226, for each connector of the number of connectors, tightens each connector using the torque value associated with (or determined for) cach connector. For example, when the impact driver 104 is placed in contact with a first connector and the trigger 212 is depressed, the controller 226 may tighten the first connector via the output driver device 210 until the controller 226 determines that a torque value greater than or equal to the torque value associated with the first connector is applied to the first connector. In some embodiments, the controller 226 may be configured to determine the torque value applied to a connector using anvil position signals from the anvil position sensor 218c, hammer position signals from the hammer position sensor 218d, and/or signals from the Hall sensors 218a indicative of rotor speed. In other embodiments, the controller 226 may determine the torque applied to a connector based on a torque value measurement received from a torque sensor (not illustrated) that is coupled to the anvil shaft 1220. In some embodiments, after the first connector is tightened, the controller 226 may determine that the impact driver 104 has been placed in contact with a subsequent connector using dead-reckoning. However, in other examples, the controller 226 may determine that the impact driver 104 has been placed in contact with subsequent connectors using other determination types, as required for a given application. When the trigger 212 is depressed, the controller 226 may tighten the subsequent connector via the output driver device 210 until the controller 226 determines that a torque value greater than or equal to the torque value associated with the subsequent connector is applied to the subsequent connector. The controller 226 may continue to determine that the impact driver 104 has been placed in contact with a subsequent connector and tighten the subsequent connector using the torque associated with the subsequent connector until each connector of the plurality of connectors is tightened.

While the controller 226 is described in relation to the process 1600 as determining a torque value for each connector of a plurality of connectors and tightening cach connector of the plurality of connectors using the torque associated with the connector, in some embodiments, the controller 226 determines a number of impacts for each connector of a plurality of connectors rather than a torque value. The controller 226 may tighten a connector of the plurality of connectors using the number of impacts associated with the connector. The number of impacts determined for a connector of the plurality of connectors may be a number of impacts required to be delivered to the connector by the impact driver 104 to ensure a desired strain on the connector is achieved after each connector required to install a component is tightened.

While the embodiments described above reference flanging behavior which causes the strain placed a connector to decrease as subsequent connectors are tightened, in some embodiments, the flanging behavior of a component may cause the strain placed on a connector to increase as subsequent connectors are tightened. In embodiments where the flanging behavior of a component causes the strain placed on a connector to increase rather than decrease as subsequent connectors are tightened, a second method similar to the process 1600 may be performed by the controller 226. Unlike in the process 1600, in the second process, connectors are under tightened rather than overtightened. In the second method, the smallest required torque is associated with (or determined for) the first connector tightened and the required torque determined for each subsequent connector increases until the final connector is tightened. In the second method, as in the method 1600, the final connector tightened may be associated with a torque required to achieve a desired level of strain for a given application.

What is claimed is:

1. An impact driver comprising:
a controller, the controller configured to:
receive a number of connectors associated with a fastening operation;
for each connector of a plurality of connectors equal to the number of connectors,
determine, based on the number of connectors and an overall desired torque value for the fastening operation, an individual desired torque value for each connector of the plurality of connectors, wherein a first individual desired torque value for a first connector to be tightened is greater than an individual desired torque value for each of one or more subsequent connectors of the plurality of connectors to be tightened, and the individual desired torque values for each subsequent connector to be tightened is less than the individual desired torque value of a previous connector to be tightened; and
control an output of the impact driver to tighten each connector using the individual desired torque value determined for each connector to achieve the overall desired torque value for the fastening operation.

2. The impact driver according to claim 1, wherein the controller is further configured to determine the desired torque value for each connector based on a stored mathematical equation and the received number of connectors.

3. The impact driver of claim 1, wherein the controller is further configured to:
receive a type of connector associated with the fastening operation; and
determine the desired torque value for each connector based on the received type of connector.

4. The impact driver according to claim 1, wherein the controller is configured to determine the desired torque value for each connector using a machine learning model.

5. The impact driver according to claim 1, wherein the controller is further configured to receive a fastening mode.

6. The impact driver according to claim 5, wherein the controller is further configured to determine the overall desired torque value for the fastening operation based on the received fastening mode and the received number of connectors.

7. The impact driver according to claim 1, wherein the desired torque value for a final connector tightened is associated with a final desired torque level for each of the plurality of connectors upon completion of the fastening operation.

8. A method for controlling a power tool to compensate for changes in strain in a multiple connector fastening operation, comprising:
receiving a number of connectors associated with the multiple connector fastening operation;
determining, for each connector of a plurality of connectors equal to the number of connectors, an individual desired torque value for each connector of the plurality of connectors, based on the received number of connectors and an overall desired torque value for the fastening operation, wherein a first individual desired torque value for a first connector to be tightened is greater than the individual desired torque value for each of one or more subsequent connectors of the plurality of connectors to be tightened, and wherein the individual desired torque values for each subsequent connector to be tightened is less than the individual desired torque value of a previous connector to be tightened;
controlling an output of the power tool to tighten each connector of the plurality of connectors to be tightened to achieve the overall desired torque value for the multiple connector fastening operation.

9. The method of claim 8, wherein the method further comprises determining the desired torque value for each connector based on a stored mathematical equation and the received number of connectors.

10. The method of claim 8, further comprising:
receiving a type of connector associated with the fastening operation; and
determining the desired torque value for each connector based on the received type of connector.

11. The method of claim 8, further comprising determining the desired torque value for each connector using a machine learning mode.

12. The method of claim 8, further comprising receiving a fastening mode associated with the multiple connector fastening operation.

13. The method of claim 12, further comprising determining the overall desired torque value for the multiple connector fastening operation based on the received fastening mode and the received number of connectors.

14. The method of claim 8, wherein the desired torque value for a final connector tightened is associated with a final desired torque level for each of the plurality of connectors upon completion of the fastening operation.

15. The method of claim 8, wherein the power tool is an impact driver.

16. An impact driver, comprising:
a controller, the controller configured to:
receive a number of connectors associated with a fastening operation;
receive a type of connector associated with the number of connectors;
for each connector of a plurality of connectors equal to the number of connectors
determine a desired torque value for each connector based on the received type of connector;
determine, based on the number of connectors, the type of connectors, and an overall desired torque value for the fastening operation, an individual desired torque value for each connector of the plurality of connectors, wherein a first individual desired torque value for a first connector to be tightened is greater than an individual desired torque value for each of one or more subsequent connectors of the plurality of connectors to be tightened, and the individual desired torque values for each subsequent connector to be tightened is less than the individual desired torque value of a previous connector to be tightened; and
control an output of the impact driver to tighten each connector using the individual desired torque value determined for each connector to achieve the overall desired torque value for the fastening operation.

17. The impact driver of claim 16, wherein the controller is further configured to determine the desired torque value for each connector based on a stored mathematical equation, the received number of connectors, and the type of connectors.

18. The impact driver of claim 16, wherein the controller is further configured to receive a fastening mode associated with the fastening operation.

19. The impact driver of claim 18, wherein the controller is further configured to determine the overall desired torque value for the fastening operation based on the received fastening mode and the received number of connectors.

20. The impact driver of claim 16, wherein the desired torque value for a final connector tightened is associated with a final desired torque level for each of the plurality of connectors upon completion of the fastening operation.
